(19) United States
(12) Patent Application Publication
(10) Pub. No.: US 2013/0076346 A1
(43) Pub. Date: Mar. 28, 2013

(54) System and method of determining relative position

(71) Applicant: Michael Subrt, Chillicothe, IL (US)

(72) Inventor: Michael Subrt, Chillicothe, IL (US)

(73) Assignee: CATERPILLAR INC., Peoria, IL (US)

(21) Appl. No.: 13/243,349

(22) Filed: Sep. 23, 2011

(51) Int. Cl. G01B 7/14

(52) U.S. Cl. 324/207.22

(57) ABSTRACT

A system is configured to determine the displacement of a moveable member relative to a reference member. A set of sensors is fixed relative to one of the reference member and moveable member. An array of encoded words is provided. The encoded words define each position of the moveable member along a first direction. Each encoded word includes a plurality of indicia and each indicia is a multi-level logic unit configured as one of at least two states. The position of the encoded words relative to the set of sensors defines a position of the movable member along a second direction.

### TECHNICAL FIELD

This disclosure relates generally to a system and method for determining the position of a movable member relative to a reference member and, more particularly, to a system and method for determining the position of the movable member in two different directions.

### BACKGROUND

Many systems measure the displacement of a movable member relative to a reference member to determine the location of an element connected to the movable member. For example, knowing the distance that a shaft within a hydraulic cylinder is extended may be sufficient to determine the location of an implement connected to the hydraulic cylinder. In some systems, the location of an element may be determined by monitoring sensors that read or sense the location of indicia positioned on the movable member.

U.S. Patent Application Publication No. 2010/0039103 A1 discloses a system for determining the position of a movable member with respect to a fixed member. The movable member includes a first and second magnet and a secondary magnet. A sensor assembly on the fixed member detects the first and secondary magnets and thus determines the axial position of the movable member relative to the fixed member.

In systems in which the movable member may move in more than one direction, measurement of displacement in a single direction may be insufficient to accurately determine the location of an attached element. In addition, determining the location of an element may be especially complex when the element is driven or connected to more than one movable member. In such case, it may be necessary to determine the movement of each of the movable members in more than one direction to determine the location of the attached element.

The foregoing background discussion is intended solely to aid the reader. It is not intended to limit the innovations described herein nor to limit or expand the prior art discussed. Thus the foregoing discussion should not be taken to indicate that any particular element of a prior system is unsuitable for use with the innovations described herein, nor is it intended to indicate any element, including solving the motivating problem, to be essential in implementing the innovations described herein. The implementations and application of the innovations described herein are defined by the appended claims.

### SUMMARY

In one aspect, a system for determining the displacement of a moveable member relative to a reference member is provided. The moveable member is configured for movement relative to the reference member along a range of positions in a first direction and in a second direction. A set of sensors is fixed relative to one of the reference member and moveable member. An array of encoded words on another of the reference member and moveable member is provided. The encoded words define the positions of the moveable member along the first direction and a position of the encoded words relative to the set of sensors defines the positions of the movable member along the second direction. Each encoded word includes a plurality of indicia and each indicia is a multi-level logic unit configured as one of at least two states.

In another aspect, a method is provided for determining the displacement of a moveable member relative to a reference member. The moveable member is configured for movement relative to the reference member along a range of positions in a first direction and in a second direction. A set of sensors is provided together with an array of encoded words on the moveable member. The encoded words define the positions of the moveable member along the first direction and includes a plurality of indicia. Each indicia is a multi-level logic unit that is configured as one of at least two states. Upon moving the moveable member relative to the reference member, the indicia of an encoded word aligned with some of the sensors are sensed. The displacement of the moveable member along the first direction is determined based upon the sensed indicia. The displacement of the movable member along the second direction is determined based upon the position of the sensed indicia.

### BRIEF DESCRIPTION OF THE DRAWINGS

FIG. 1 is a diagrammatic view of a cylinder assembly together with a system for determining displacement in two directions as disclosed herein;

FIG. 2 is a section taken generally along line 2-2 of FIG. 1;

FIG. 3 is a side view of a motor grader in which the system disclosed herein may be incorporated;

FIG. 4 is a table illustrating an array of indicia depicting encoded words and a pair of border sequences for use in determining displacement in first and second directions;

FIG. 5 is an alternate table that is similar to FIG. 4 but with the encoded words shifted one column to the left;

FIG. 6 is an alternate of a table that is similar to FIG. 4 but with the columns for determining the angular position located within the encoded words;

FIG. 7 is an alternate of a table that is similar to FIG. 4 but with the encoded words repeated on opposite sides of the indicia designating the borders of central encoded words;

FIG. 8 is an alternate of a table that is similar to FIG. 4 but with duplicate rows of encoded words deleted;

FIG. 9 is an alternate of a table with the encoded words depicted as a binary counting sequence and uniform border;

FIG. 10 is an alternate of a table that is similar to FIG. 9 but with certain encoded words deleted and the border modified; and

FIG. 11 is an alternate of a table that is similar to FIG. 10 but with the binary counting sequence replaced with a Gray code sequence.

### DETAILED DESCRIPTION

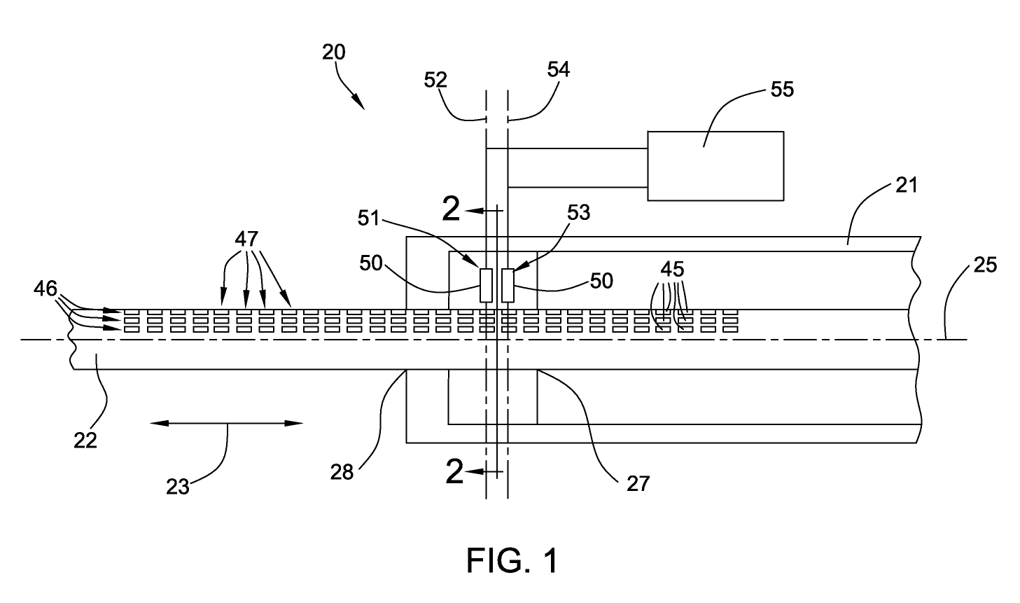

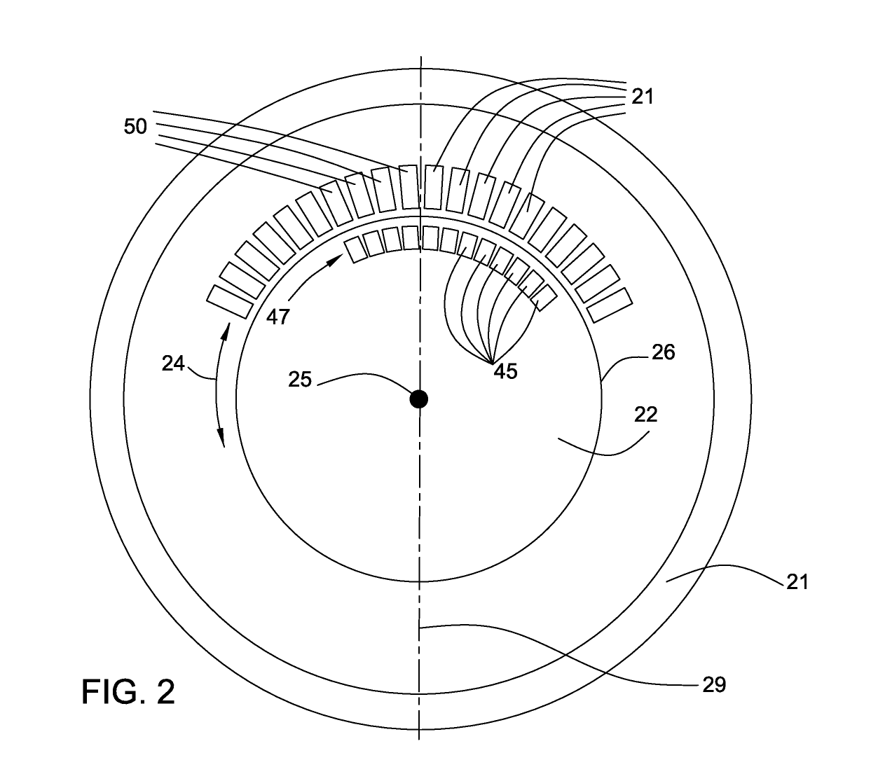

FIG. 1 depicts a system 20 for determining displacement of a moveable member in one or more directions relative to a reference member. In one embodiment, system 20 may include a hydraulic cylinder 21 with an elongated shaft 22 configured for movement relative to the hydraulic cylinder 21 generally along the generally linear path of travel 23 of the elongated shaft. Elongated shaft 22 may also rotate to some extent within hydraulic cylinder 21. System 20 is configured to determine the amount of displacement in a first direction, such as along the generally linear path of travel 23 of elongated shaft 22, as well as in a second direction, such as along arcuate path 24 generally about the axis of rotation 25 of the elongated shaft 22 (FIG. 2).

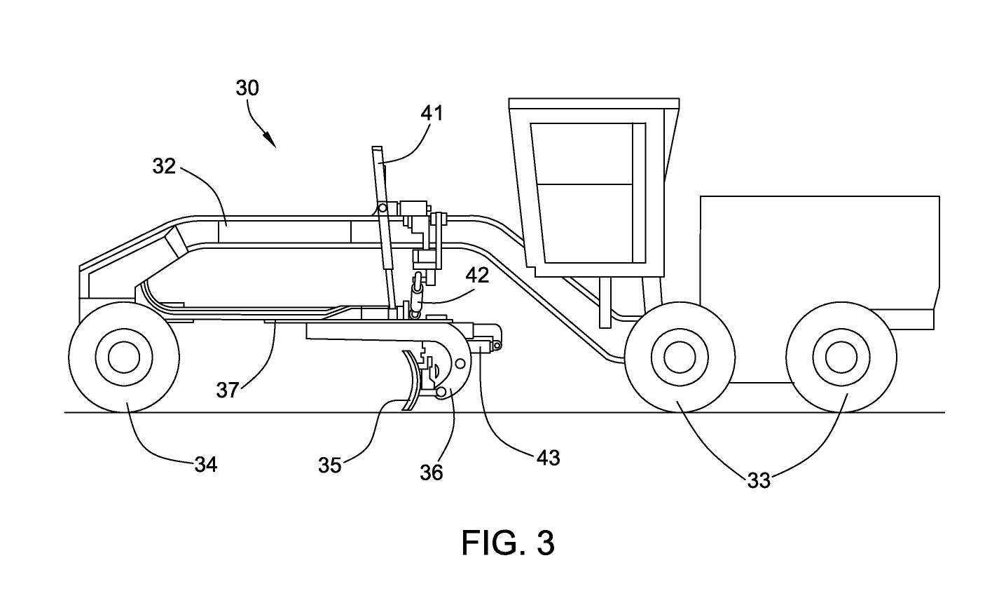

Referring to FIG. 3, a motor grader is depicted generally at 30. The motor grader 30 has a frame 32, two sets of rear wheels 33 and a set of front wheels 34. A blade or moldboard 35 is mounted on blade tilt adjustment mechanism 36 that is supported by rotatable circle assembly 37 disposed beneath frame 32. A variety of hydraulic cylinders may be provided for controlling the position of moldboard 35. For example, circle assembly 37 is supported by a pair of blade lift actuators 41 (with only one visible in FIG. 3). Adjustment of the blade lift actuators 41 allows the height of circle assembly 37, and hence the height of moldboard 35, to be adjusted. Blade lift actuators 41 may be moved independently or in combination with one another. Center shift cylinder 42 may be provided to shift the circle assembly 37 from side-to-side. Blade tip cylinder 43 may be provided to control the angle between the edge of moldboard 35 and the ground. One or more side shift cylinders (not shown) may be provided to control lateral movement of the moldboard 35 relative to the circle assembly 37.

In a machine such as motor grader 30 that utilizes multiple hydraulic cylinders to control an implement, rotation of the elongated shaft within some or all of the cylinders may affect the positioning of the implement, As a result, it may be difficult to determine the position of the implement by measuring displacement of the hydraulic cylinders in a single direction. In other words, the position of the implement may be affected by not only the linear displacement of each of the shafts of hydraulic cylinders but also by the rotation of the shafts. Accordingly, some or all of the hydraulic cylinders that control the position of moldboard 35 may include the system 20 for determining the displacement of the shaft of each cylinder in both a first direction along the generally linear path of travel 23 and along a second direction along an arcuate path 24 generally about the axis of rotation 25. Determining both the linear displacement of elongated shaft 22 as well as its rotation may allow the position of the moldboard 35 to be determined based on the positions of the various hydraulic cylinders, and thus simplify the operation of the motor grader 30. Further, utilizing the system 20 may allow the position of the moldboard 35 to be determined by monitoring fewer than all of the hydraulic cylinders that control the moldboard.

Referring to FIGS. 1-2, displacement of elongated shaft 22 may be determined by providing a plurality of indicia 45 along a length of the elongated shaft 22. The indicia 45 may be organized as a series of columns 46 and rows 47 and form a plurality of rows of encoded words 48. The encoded words may be spaced apart along the path of travel 23 of elongated shaft 22. Columns 46 of indicia 45 may be provided that act as a boundary or border signifying the ends of the encoded words 48 and may be generally parallel to the direction or path of travel 23 of elongated shaft 22. The borders may act as start and/or stop bits at the beginning and end of the encoded words 48 to assist in determining the rotational position of the elongated shaft 22.

The indicia 45 may be provided along arcuate outer surface 26 of elongated shaft 22. In one configuration, the indicia 45 may be magnetic elements that are positioned adjacent or below the outer surface 26 of the elongated shaft 22. In another configuration, the indicia 45 may be optically reflective elements that are positioned on the outer surface 26 of the elongated shaft 22. In the embodiment depicted in FIGS. 1-2, the indicia 45 are positioned in arcuate paths or rows 47 so as to be generally parallel to the arcuate outer surface 26 of the elongated shaft 22.

A plurality of sensors 50 may be mounted on hydraulic cylinder 21 for sensing the status and position of the indicia 45. More specifically, a first set 51 of sensors may be positioned generally in a first plane 52 and a second set 53 of sensors may be generally positioned in a second plane 54. As best seen in FIG. 1, the first plane 52 and the second plane 54 are generally parallel to each other and are generally perpendicular to the path of travel 23. The sensors 50 may be arranged along an arcuate path (FIG. 2) along the outer surface 26 of elongated shaft 22. The first set 51 of sensors and the second set 53 of sensors may each include an identical number of sensors 50. The number of sensors 50 within each set may be greater than the number of indicia 45 within each row 47 along elongated shaft 22 as depicted in FIG. 2. The number of indicia 45 in a row 47 and the number of sensors 50 may be established based upon the desired number of positions to be detected along the first direction of travel or the generally linear path of travel 23 together with the range of motion in or along the second direction of travel or arcuate path 24. The number of sensors may be sufficient to read or sense the indicia 45 of each encoded word 48 and also read or sense the position of the elongated shaft 22 along arcuate path 24. The first set 51 of sensors and the second set 53 of sensors are coupled to a controller 55 to determine the displacement of elongated shaft 22 along the path of travel 23 and arcuate path 24.

If desired, the sensors 50 may be positioned within the hydraulic cylinder 21 as depicted in FIG. 1. In one example, the sensors may be positioned between hydraulic seal 27 and dust seal 28 of the hydraulic cylinder 21. When used with magnetic indicia, each sensor 50 may be a magnetic field sensor configured to sense the magnetic field of each of the indicia 45. When used with multi-level logic units configured with three or more states, each sensor 50 may be analog magnetic field sensor. When used with multi-level logic units configured with only two states or binary operation, each sensors 50 may be a digital or an analog magnetic field sensor.

Controller 55 may be an electronic controller that operates in a logical fashion to perform operations, execute control algorithms, store and retrieve data and other desired operations. The controller 55 may include or access memory, secondary storage devices, processors, and any other components for running an application. The memory and secondary storage devices may be in the form of read-only memory (ROM) or random access memory (RAM) or integrated circuitry that is accessible by the controller 55. Various other circuits may be associated with the controller 55 such as power supply circuitry, signal conditioning circuitry, driver circuitry, and other types of circuitry. The controller 55 may be a single controller or may include more than one controller disposed to control various functions and/or features together with system 20. The functionality of the controller 55 may be implemented in hardware and/or software without regard to the functionality.

One or more data maps relating to the position of the elongated shaft 22 may be stored in the memory of controller 55. Each of these maps may include a collection of data in the form of arrays, tables, graphs, and/or equations. In one example, the position of the elongated shaft 22 along the path of travel 23 and about the arcuate path 24 may be determined by comparing the indicia read or sensed by sensors 50 with the data maps associated with controller 55.

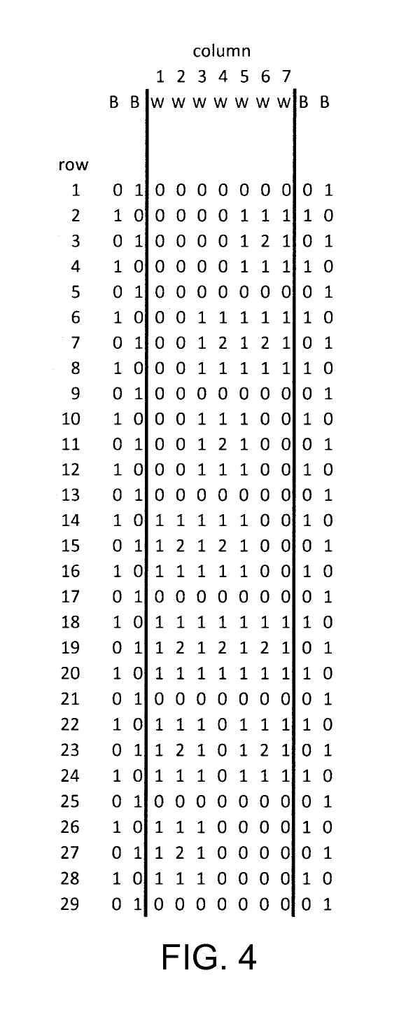

FIG. 4 depicts an example of encoding used with the indicia 45 to create the array of encoded words 48 and the columns 46 that define the borders. More specifically, each indicia 45 forming the array of encoded words 48 may be a multi-level logic unit configured as one of at least three states. Each of the states is represented in FIG. 4 by a “0,” a “1,” or a “2.” Each pair of adjacent columns 46 that form a border of the array of the encoded words 48 may be configured as a multi-level logic unit configured as one of two states or as a binary logic unit. Each row 47 has an encoded word 48 formed of a plurality of indicia 45 between each of the borders. In FIG. 4, the columns 46 of indicia 45 that define the border are labeled with a “B” and the columns of indicia that define the encoded words 48 are labeled with a “W.” For example, the encoded word of row 1 is “0000000,” the encoded word of row 2 is “0000111,” and the encoded word of row 3 is “0000121.” Each pair of adjacent encoded words 48 (along path of travel 23) is a unique pattern and defines one of the positions of the elongated shaft 22 along the path of travel 23. The indicia 45 forming the encoded words may define an array of first indicia and the indicia 45 forming the borders may define an array of second indicia.

The first set 51 of sensors reads or senses the status of a first encoded word within the array and the second set 53 of sensors reads or senses the status of a second encoded word 48. The array of indicia 45 is configured so that the encoded words sensed by the first set 51 of sensors and the second set 53 of sensors define a unique position of the elongated shaft 22 along the path of travel 23. As depicted, the first set 51 of sensors and a second set 53 of sensors are spaced apart along the path of travel 23 by a distance generally equal to the spacing between the indicia 45 forming the encoded words 48. In such a configuration, the pairs of adjacent encoded words 48 define a plurality of positions of the elongated shaft 22 along the path of travel 23. The spacing between and number of rows 47 of indicia 45 define the number of unique positions of the shaft that may be determined. More specifically, each encoded word 48 defines a position of the elongated shaft 22 along the path of travel 23 and thus the indicia 45 define a range of positions through or along the path of travel. The spacing of the indicia 45 along the path of travel 23 (and thus within each column 46) define the spacing between the positions that may be measured along the path of travel.

It should be noted that in some situations, the spacing between the first set 51 of sensors and the second set 53 of sensors may be set so that the encoded words 48 being read or sensed by the sensors 50 are not adjacent to each other. In such case, the spacing between the encoded words 48 utilized to define each position of the elongated shaft 22 along the path of travel 23 remains a fixed distance apart and is set by the distance between the first set 51 of sensors and the second set 53 of sensors. In other words, in the embodiment depicted in FIG. 1, the spacing between the first set 51 of sensors and the second set 53 of sensors is generally equal to the distance or pitch between rows 47 of indicia 45. However, if the first set 51 of sensors and the second set 53 of sensors are spaced apart by a distance equal to twice the distance between rows 47 of indicia 45, the sensors 50 will read or sense the indicia 45 aligned with the respective rows of sensors and the controller 55 will determine the position of the elongated shaft 22 based upon the encoded words aligned with the sensors. In such case, the array of encoded words 48 may need to be modified to ensure that the pair of encoded words read by the sensors define a unique position of the elongated shaft 22.

The identity of the encoded words 48 aligned with the first set 51 of sensors and the second set 53 of sensors defines the position of elongated shaft 22 along path of travel 23 while the alignment of the encoded words with specific ones of the sensors 50 defines the position of the elongated shaft 22 along arcuate path 24. More specifically, the first set 51 of sensors and the second set 53 of sensors read or sense the status of the indicia 45 aligned therewith and which of the sensors 50 are aligned with the columns 46 of indicia 45 defining the borders. This configuration permits the controller 55 to determine the linear position of the elongated shaft and the position of elongated shaft 22 about the arcuate path 24.

In some embodiments, columns 46 of indicia 45 configured as one or more borders may be included to increase the reliability of the system 20 when determining the angular position of the elongated shaft 22. By determining which sensors 50 are aligned and interact with the columns 46 that define the borders, the amount of rotation about axis of rotation 25 may be determined and thus the angular position of elongated shaft 22. For example, referring to FIGS. 1-2, the elongated shaft 22 is displaced or extended slightly more than halfway out of the hydraulic cylinder 21 and is rotated slightly clockwise relative to a symmetrical position in which half of the indicia 45 are on opposite sides of a vertical centerline 29 through the elongated shaft 22. As such, the first set 51 of sensors and the second set 53 of sensors reads or senses the indicia 45 and the controller 55 determines the encoded words 48 aligned with the sensors 50 and also determines the location of the borders. (If the array of indicia does not include borders, the controller 55 may be configured to determine the angular position based upon the angular or rotational positions of the encoded words 48.) With this information, the controller 55 is able to determine the position of elongated shaft 22 along the path of travel 23 and about the arcuate path 24.

As stated above, each of the indicia 45 that defines the encoded words 48 may be a multi-level logic unit configured as one of at least three states. In one example, the indicia may be magnetic elements with a “0” being configured as a “North” magnetic polarity or designation, a “1” being configured as a neutral polarity or designation, and a “2” being configured as a “South” magnetic polarity or designation. In other words, the first state generally corresponds to a first designation, the third state generally corresponds to an opposite designation, and the second state generally corresponds to a designation generally midway between the first designation and the third designation. When magnetizing each of the magnetic elements in such a configuration, all of the indicia 45 may first be magnetized as a “North” magnetic polarity. Each of the indicia 45 that are desired to be configured as a “1” or a “2” may then be magnetized with an opposite or “South” polarity which, when combined with the “North” polarity, will change each of those indicia to a neutral polarity. The indicia 45 that are desired to correspond to a “2” may then be again magnetized with an additional “South” polarity. This results in the desired three states of indicia with some of the indicia having a first polarity, other indicia having an opposite polarity, and still others having a neutral polarity or designation. When the indicia 45 are magnetized as multi-level logic units configured as one of at least three states, the sensors 50 may be analog magnetic field sensors.

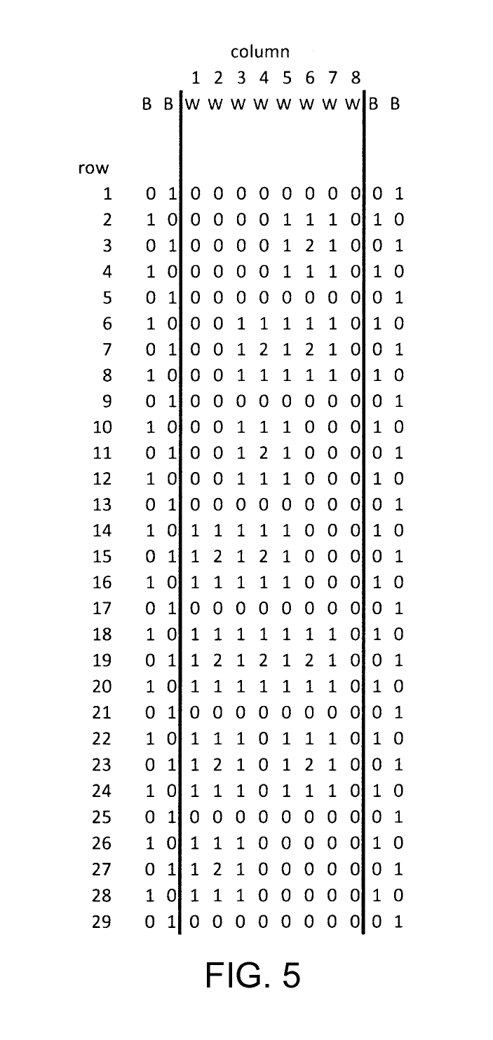

Other arrays of indicia 45 may be configured to create desired patterns of encoded words 48. For example, referring to FIG. 5, an alternate array of indicia 45 is depicted. The array of FIG. 5 is similar to the array of FIG. 4 except that a column of “0's” has been added and is indicated as column 8. The array of encoded words 48 depicted in FIG. 5 may replace the array of FIG. 4 (although it has one additional column). In the alternative, it may be combined with FIG. 4 by adding it to the bottom of the array of FIG. 4. In order to do so, columns 1-7 of FIG. 4 would be shifted to the right (so as to be aligned with columns 2-8 of FIG. 5) and a column of “0's” added in column 1. This would create additional encoded words that define additional positions of the elongated shaft 22 along the path of travel 23 and approximately double the number of defined positions along elongated shaft 22 while only adding one addition column 46 of indicia. If the array of encoded words of FIG. 5 is added to the array of FIG. 4, one of the rows of “0's” between the two arrays is deleted to avoid two adjacent rows of “0's.”

It should be noted that in the embodiment depicted in FIG. 4, each of the indicia configured as a “2” is surrounded by an indicia configured as a “1.” In some situations, such an array or pattern may be desirable. Other arrays of indicia may be utilized. If desired, rather than utilizing a three state multi-level logic unit, a greater number of states may be used. For example, the array of indicia 45 could include four or more different states (e.g., 0, 1, 2, 3). In such case, the indicia may be generally equally spaced apart within a range of values. Further, in some systems, it may be desirable to utilize a multi-level logic unit having only two states or operating in a binary manner. In such case, the sensors 50 may be analog or binary and it may be desirable to implement an alternate system for designating the border of the encoded words 48 so as to maintain the uniqueness of the encoded words and distinguish the borders from such words.

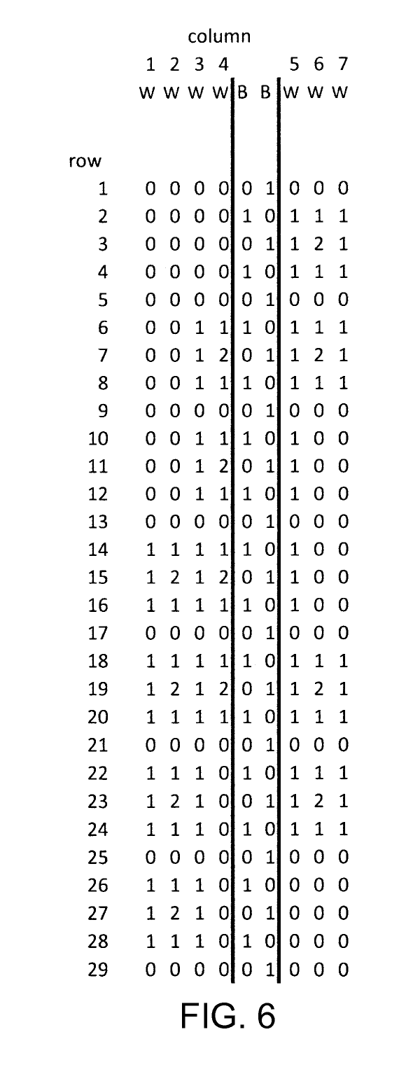

Although FIG. 4 depicts the indicia 45 defining an array of encoded words 48 together with a border on each side of the encoded words, it may be possible to eliminate the borders or utilize a single border at one end of the encoded words 48. In such case, a greater number of sensors 50 within the first set 51 and the second set 53 may be necessary. In another alternate embodiment, it may be possible to bisect the encoded words 48 with a pair of columns as depicted in FIG. 6 that function to identify the rotational position of the elongated shaft 22. In such case, columns 1-4 and 5-7 are bisected by the rotational position identifying columns that are labeled with “B.” Accordingly, the encoded words 48 defined by columns 1-4, 5-7 of FIG. 6 are identical to the encoded words defined by columns 1-7 in FIG. 4. The sensors 50 together with the controller 55 may function to determine the linear and angular position of the elongated shaft 22 in a manner similar to that described above.

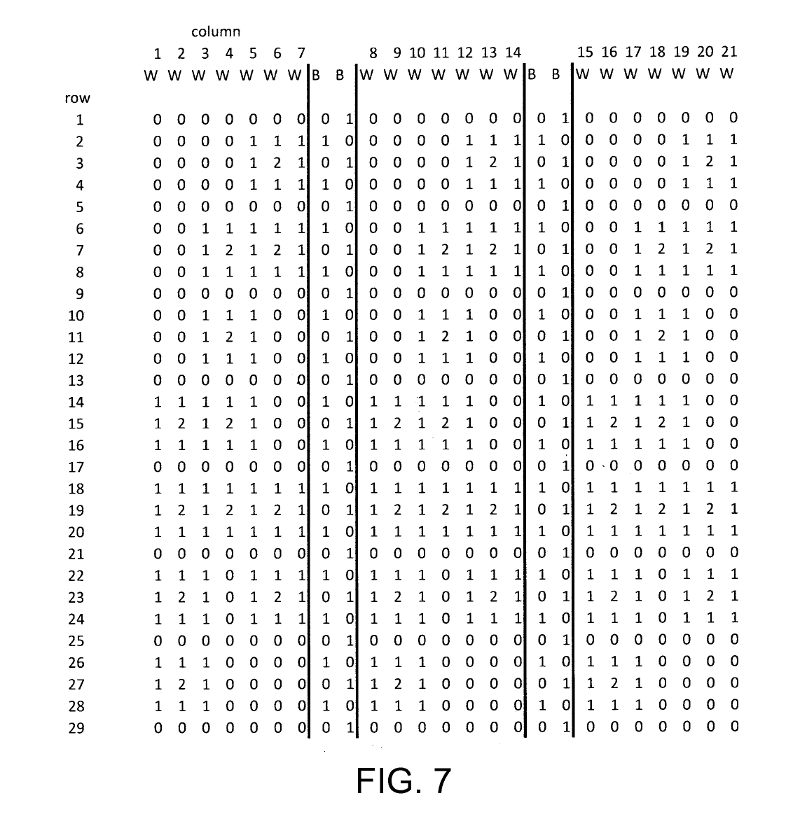

In still another alternate embodiment, FIG. 7 depicts an array of indicia 45 with each row having three identical encoded words and two sets of borders between the encoded words. In some situations, such a configuration may be utilized to determine a greater range of rotation about the outer surface 26 of elongated shaft 22. It may be desirable to include enough sensors so that the positions of both columns of border may be determined. In other configurations, it may desirable to configure the borders with different codes, for example, such as by configuring one border with alternating “0's” and “1's” while configuring another border with alternating “0's” and “2's. Through the use of different borders, it may be possible to determine the rotational or angular position of elongated shaft 22 with fewer sensors 50 as compared to a system having identical borders.

While the moveable member is depicted as an elongated shaft 22 that is moveable in a first direction along generally linear path of travel 23 and in a second direction about arcuate path 24, the concepts disclosed herein may also be applicable to a moveable member that is moveable in two directions that are generally perpendicular or orthogonal to each other. In such case, the array of indicia 45 may be configured in a generally planar manner and the first set 51 of sensors and the second set 53 of sensors may both be in a linear array rather than in an arcuate array.

Although described above with respect to magnetic indicia 45 and sensors 50, the indicia 45 and the sensors 50 may operate through other mediums. For example, the indicia 45 and the sensors 50 may be optical rather than magnetic. In such case, the indicia 45 may be configured with different degrees of reflectivity and the sensors 50 may be optical sensors configured to determine the amount of reflection from the indicia. In one example, a “0” may be approximately one hundred percent reflective, a “1” may be approximately fifty percent reflective, and a “2” may be generally non-reflective. Additional states may be added by defining different points of reflectively between one hundred percent reflective and generally non-reflective. For example, “0” may be approximately one hundred percent reflective, “1” may be approximately sixty-six percent reflective, “2” may be approximately thirty-three percent reflective, and “4” may be generally non-reflective.

As depicted, the border is configured utilizing columns 46 of indicia 45 with a repeating pattern of states “0” and “1.” However, other or additional borders may be utilized using other combinations of states such as “0” and “2” or “1” and “2.” In addition, the borders could use multi-level logic units configured with three or more states as described above with respect to the encoded words 48. Such additional or different borders could be used to determine the rotational displacement without monitoring or sensing all of the indicia 45 within each row. In another configuration, it may be desirable to re-use or duplicate the array of encoded words but change the border within a row of indicia. This would permit the measurement of additional positions along the path of travel 23 without adding additional columns of indicia. As an example, the array of FIG. 4 permits the measurement of twenty eight different positions along the path of travel 23. By adding additional rows of indicia and repeating the encoded words but changing the columns of the borders so as to alternate “0's” and “2's,” twenty seven additional positions along the path of travel 23 may be identified.

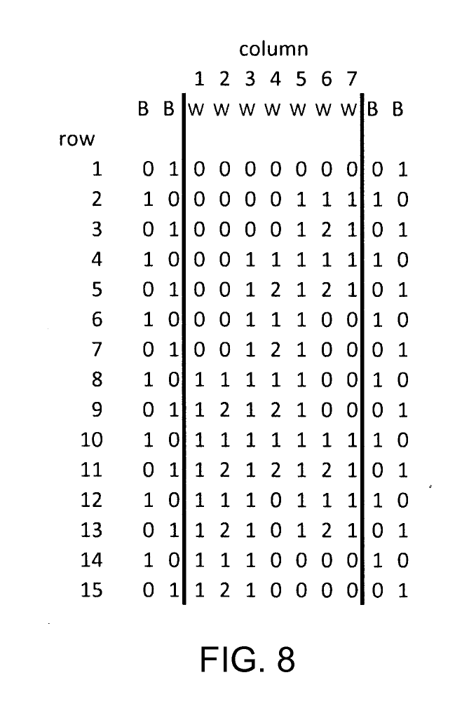

In another configuration, system 20 (FIG. 1) may be modified so as to include only the first set 51 of sensors 50 for determining the status and position of indicia 45. In such a modified system, rather than determining the position of the elongated shaft 22 based upon reading or sensing a pair of encoded words 48, only the indicia 45 of a single encoded word 48 are read. As a result, each encoded word 48 on the elongated shaft 22 is unique and defines a unique position of the elongated shaft. In one embodiment depicted in FIG. 8, such array of indicia 45 may be multi-level logic units configured with three states and may be created by modifying the array of FIG. 4 to remove all duplicate rows 47 of encoded words. Such modified system may operate in a manner similar to system 20 but with only the first set 51 of sensors 50 providing input to the controller 55.

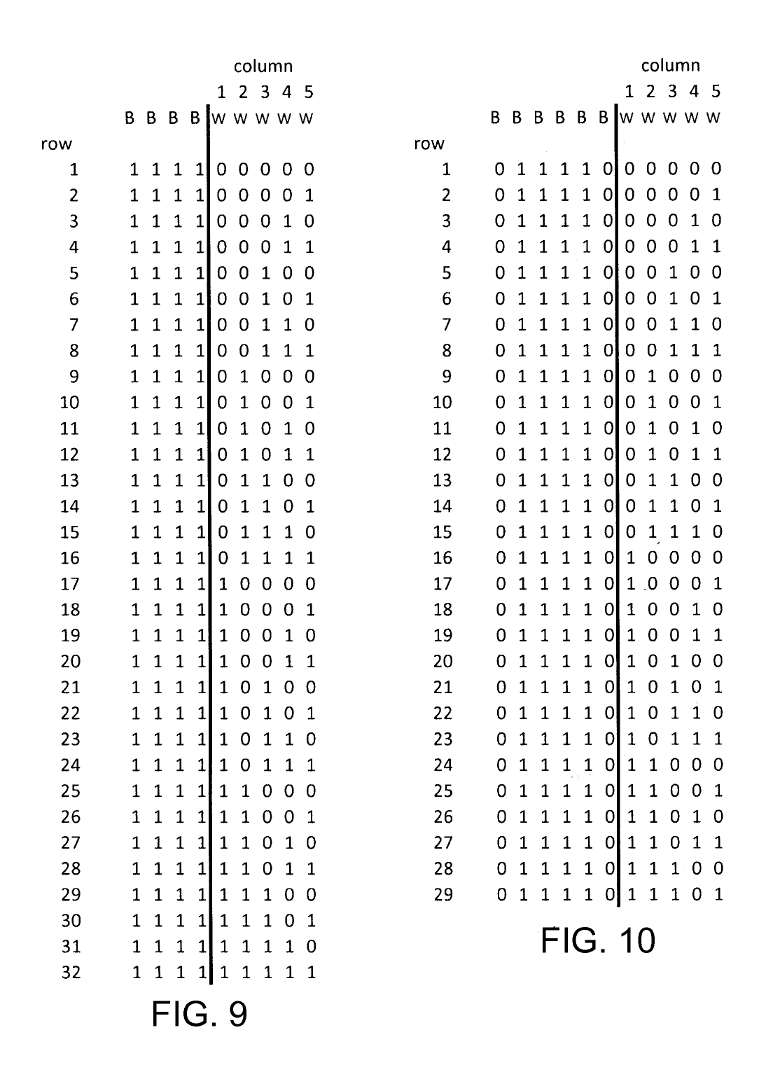

In other embodiments for use with such a modified system 20 that includes only the first set 51 of sensors 50, the array of indicia 45 defining the encoded words 48 may be multi-level logic units configured for binary operation or with only two states. For example, the encoded words 48 of the array of FIG. 9 correspond to a five bit binary counting sequence. As such, each row 47 defines a unique encoded word 48 so that each encoded word corresponds to a unique position along the elongated shaft 22. The signal processing circuitry may determine the linear position along path of travel 23 by sensing or reading the unique indicia 45 aligned with the first set 51 of sensors 50. The array of FIG. 9 further includes a series of columns 46 (labeled “B”) of indicia 45 with each indicia configured as a “1.” The signal processing circuitry may be configured to determine the angular position of the elongated shaft 22 based upon the position of the repeating pattern of four “1's.”

It should be noted that based upon the binary counting sequence, rows 16, 31 and 32 at least two repeating patterns of four “1's.” Such repeating pattern may reduce the reliability of the angular position sensing functionality. In such case, it may be desirable to eliminate the rows in which a repeating pattern of four “1's” would exist. In addition or in the alternative, it may be desirable to add additional columns 46 of border indicia 45 configured as “0's” on both ends of the borders. In such case, the border designation becomes “011110.” Referring to FIG. 10, an array of indicia 45 is depicted based upon the array of FIG. 9 but with each row 47 of encoded words having a repeating pattern of four “1's” deleted and a column of “0's” added to each end of the border. In other words, the encoded words of rows 16, 31 and 32 of FIG. 9 have been deleted and a column of “0's” added at the left-hand and right-hand ends of the columns 46 that designate the border.

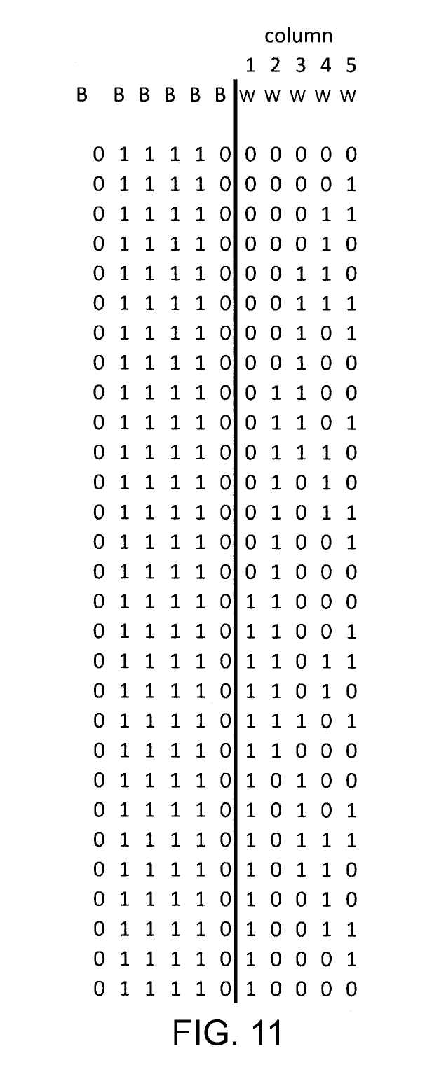

FIG. 11 depicts an array of indicia 45 similar to that of FIG. 10 but with a five bit Gray code sequence replacing the binary counting sequence. With a Gray code sequence, only one indicia 45 within each row 47 changes between adjacent rows. Under some circumstances, this may result in a system having greater reliability.

### INDUSTRIAL APPLICABILITY

The industrial applicability of the system 20 described herein will be readily appreciated from the foregoing discussion. The present disclosure is applicable to determining displacement of a moveable member relative to a reference member. The moveable member is configured for movement along a range of a positions in both a first direction and a second direction. The system permits the determination of the absolute position of the moveable member by monitoring or sensing the identity and location of encoded words positioned along the moveable member.

In one aspect, a system 20 for determining the displacement of a moveable member relative to a reference member is provided. The moveable member is configured for movement relative to the reference member along a range of positions in a first direction and in a second direction. A first set 51 of sensors is fixed relative to one of the reference member and moveable member. An array of encoded words 48 on another of the reference member and moveable member is provided. The encoded words 48 define the positions of the moveable member along the first direction and a position of the encoded words relative to the first set 51 of sensors defines the positions of the movable member along the second direction. Each encoded word 48 includes a plurality of indicia 45 and each indicia is a multi-level logic unit configured as one of at least two states.

In another aspect, a method is provided for determining the displacement of a moveable member relative to a reference member. The moveable member is configured for movement relative to the reference member along a range of positions in a first direction. A first set 51 of sensors is provided together with an array of encoded words 48 on the moveable member. The encoded words 48 define the positions of the moveable member along the first direction and includes a plurality of indicia 45. Each indicia 45 is a multi-level logic unit that is configured as one of at least three states. Upon moving the moveable member relative to the reference member, the indicia 45 of an encoded word 48 aligned with some of the sensors 50 are sensed. The displacement of the moveable member along the first direction is determined based upon the sensed indicia 45. The displacement of the movable member along the second direction is determined based upon the position of the sensed indicia 45.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for determining displacement of a movable member relative to a reference member, comprising:
the movable member configured for movement relative to the reference member along a range of positions in a first direction and in a second direction;
a set of sensors fixed relative to one of the reference member and the movable member; and
an array of encoded words on another of the reference member and the movable member, the encoded words defining the positions of the movable member along the first direction and a position of the encoded words relative to the set of sensors defining a position of the movable member along the second direction, each encoded word including a plurality of indicia, each indicia being a multi-level logic unit configured as one of at least two states.

2. The system of claim 1, wherein the reference member is a cylinder and the movable member is an elongated shaft of the cylinder, the first direction is a generally linear path of the elongated shaft and the second direction is an arcuate path generally about an axis of rotation of the elongated shaft.

3. The system of claim 2, further including an array of second indicia that interacts with the sensors to define each position of the movable member along the second direction, and wherein the indicia and the second indicia are on the elongated shaft and the set of sensors is fixed relative to the elongated shaft.

4. The system of claim 3, wherein the indicia and the second indicia are magnetic and each sensor is a magnetic field sensor configured to sense a magnetic field of one of the indicia and the second indicia.

5. The system of claim 4, wherein the indicia have three states, a first state generally corresponds to a first polarity, a third state generally corresponds to an opposite polarity, and a second state generally corresponds to a neutral polarity, and the magnetic field sensors are analog magnetic field sensors.

6. The system of claim 3, wherein the indicia and the second indicia are optical and each sensor is an optical sensor configured to sense reflection from one of the indicia and the second indicia.

7. The system of claim 1, further including an array of second indicia on the another of the reference member and the movable member that interacts with the sensors to define each position of the movable member along the second direction, and wherein the array of second indicia is a repeating pattern.

8. The system of claim 7, wherein the encoded words are configured as rows within the array of encoded words and the array of second indicia is a column of a repeating pattern.

9. The system of claim 7, wherein the array of second indicia defines a border of the array of encoded words.

10. The system of claim 7, wherein the array of second indicia is positioned within the array of encoded words.

11. The system of claim 7, further including a second array of second indicia, the array of second indicia defines a first border on one side of the array of encoded words and the second array of second indicia defines a second border on an opposite side of the array of encoded words.

12. The system of claim 1, further including a controller coupled to the set of sensors and configured to determine the displacement of the movable member relative to the reference member.

13. The system of claim 1, further including a second set of sensors fixed relative to the one of the reference member and the movable member, and wherein a pair of encoded words defines each position of the movable member along the first direction, each pair of encoded words that define each position are a fixed distance apart and the fixed distance is generally equal to a distance between the set of sensors and the second set of sensors.

14. The system of claim 13, further including an array of second indicia on the another of the reference member and the movable member that interacts with the sensors to define each position of the movable member along the second direction, and wherein the array of second indicia is a repeating pattern.

15. The system of claim 1, wherein each indicia has three states, a first state generally corresponds to a first designation, a third state generally corresponds to an opposite, third designation, and a second state generally corresponds to a designation midway between the first designation and the third designation.

16. The system of claim 15, wherein each indicia at the third state within the array of encoded words is surrounded by indicia at the second state.

17. A method of determining displacement of a movable member relative to a reference member, the movable member being configured for movement relative to the reference member along a range of positions in a first direction and in a second direction, comprising:
providing a set of sensors;
providing an array of encoded words on one of the reference member and the movable member, the encoded words defining the positions of the movable member along the first direction, each encoded word including a plurality of indicia, each indicia being a multi-level logic unit configured as one of at least two states;
moving the movable member relative to the reference member;
sensing the indicia of an encoded word aligned with at least some of the sensors;
determining the displacement of the movable member along the first direction based upon the sensed indicia of the encoded word aligned with at least some of the sensors; and
determining the displacement of the movable member along the second direction based upon positioning of the sensed indicia of the encoded word aligned with at least some of the sensors.

18. The method of claim 17, further including the steps of:
providing an array of second indicia on the movable member that interact with the sensors to define each position of the movable member along the second direction;
sensing the second indicia aligned with at least some of the sensors; and
determining the displacement of the movable member along the second direction based upon positioning of the second indicia.

19. The method of claim 18, wherein the second indicia are adjacent the encoded words.

20. A system for determining displacement of a movable member relative to a reference member, the movable member being configured for movement relative to the reference member along a range of positions in a first direction and a second direction, the system including a set of sensors and an array of encoded words, the encoded words defining the positions of the movable member along the first direction, each encoded word including a plurality of indicia, each indicia being a multi-level logic unit configured as one of at least two states, and an array of second indicia on the movable member, the system comprising:
a controller configured to:
sense the indicia of an encoded word aligned with at least some of the sensors;
determine the displacement of the movable member along the first direction based upon the sensed indicia of the encoded word aligned with at least some of the sensors;
determine the displacement of the movable member along the second direction based upon the position of the sensed indicia of the encoded word aligned with at least some of the sensors.
